(19) United States
(12) Patent Application Publication
(10) Pub. No.: US 2023/0266127 A1
(43) Pub. Date: Aug. 24, 2023

(54) Inertial Measurement Device

(71) Applicant: SEIKO EPSON CORPORATION, Tokyo (JP)

(72) Inventor: Kazuyoshi TAKEDA, Chino (JP)

(21) Appl. No.: 18/173,176

(22) Filed: Feb. 23, 2023

(30) Foreign Application Priority Data
Feb. 24, 2022 (JP) 2022-027090

(51) Int. Cl. G01C 21/16

(52) U.S. Cl. CPC G01C 21/16

(57) ABSTRACT

An inertial measurement device includes: an inertial sensor; a first circuit board disposed on one side of the inertial sensor; a second circuit board that is disposed on an opposite side of the first circuit board from the inertial sensor and on which a heat-generating component is mounted; and a housing configured to accommodate the inertial sensor, the first circuit board, and the second circuit board. The first circuit board and the second circuit board are separated from each other and are electrically coupled to each other via a cable.

The present application is based on, and claims priority from JP Application Serial Number 2022-027090, filed Feb. 24, 2022, the disclosure of which is hereby incorporated by reference herein in its entirety.

### BACKGROUND

### 1. Technical Field

The present disclosure relates to an inertial measurement device.

### 2. Related Art

An inertial measurement device disclosed in JP-A-2021-056197 includes a sensor unit including at least one inertial sensor, and a board. A processing unit that processes a detection signal of the inertial sensor and a display unit that displays the detection signal are mounted on the board.

However, since the inertial sensor in the sensor unit is likely to be affected by a temperature, if a heat-generating element is provided on the board, heat may be transferred to the inertial sensor and detection accuracy of the inertial sensor may be reduced.

### SUMMARY

An inertial measurement device according to the present disclosure includes: an inertial sensor; a first circuit board disposed on one side of the inertial sensor; a second circuit board that is disposed on an opposite side of the first circuit board from the inertial sensor and on which a heat-generating component is mounted; and a housing configured to accommodate the inertial sensor, the first circuit board, and the second circuit board.

### BRIEF DESCRIPTION OF THE DRAWINGS

FIG. 1 is an exploded perspective view showing an inertial measurement device according to a preferred embodiment.

FIG. 2 is a cross-sectional view showing an inside of the inertial measurement device.

FIG. 3 is a plan view showing an inside of an inertial sensor unit.

FIG. 4 is a plan view showing an upper surface of the inertial sensor unit.

FIG. 5 is a plan view showing an upper surface of a first circuit board.

FIG. 6 is a plan view showing an upper surface of a second circuit board.

FIG. 7 is a plan view showing an upper surface of the inertial measurement device.

### DESCRIPTION OF EXEMPLARY EMBODIMENTS

Hereinafter, an inertial measurement device according to the present disclosure will be described in detail based on a preferred embodiment shown in the accompanying drawings.

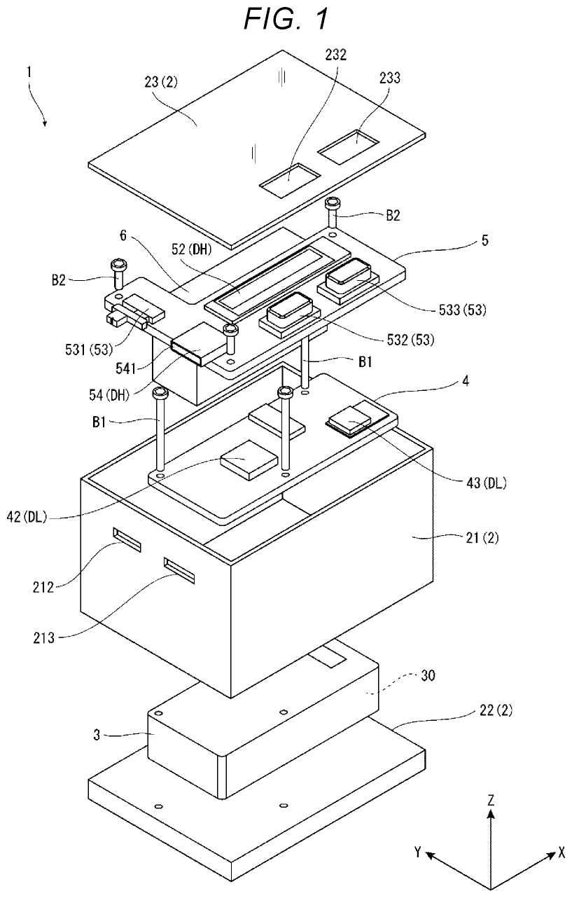

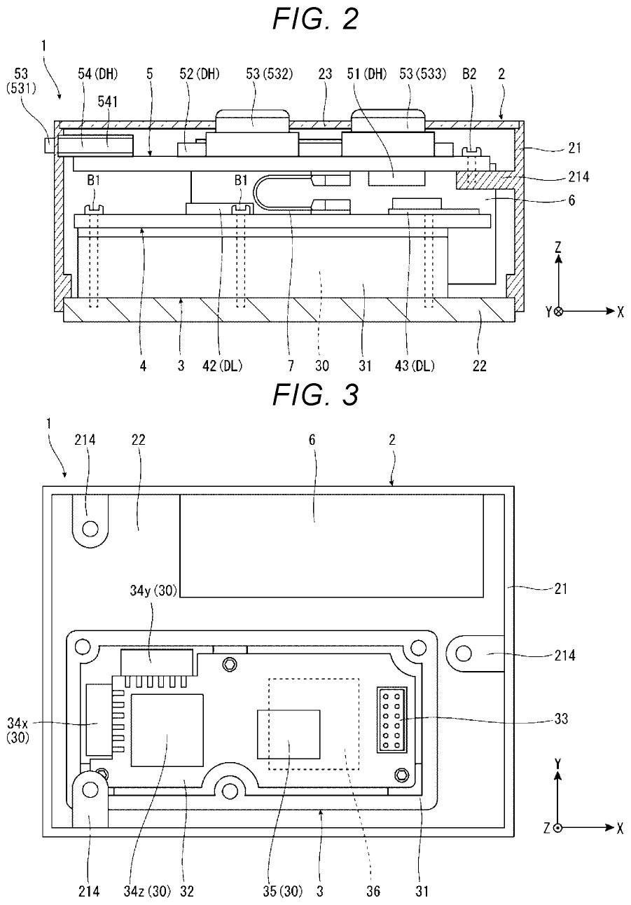

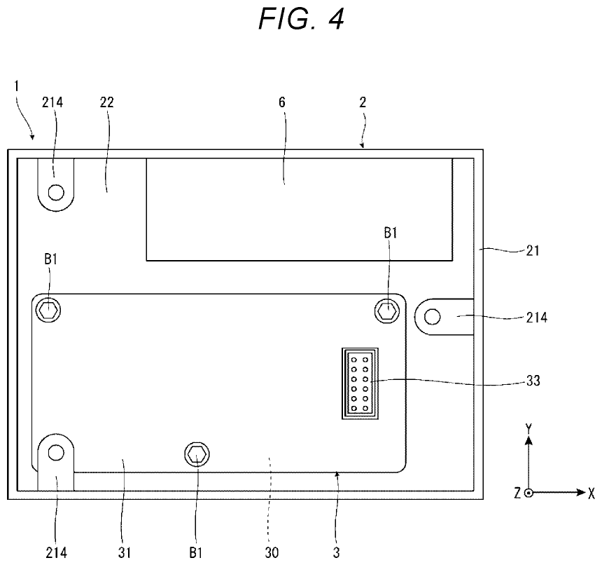

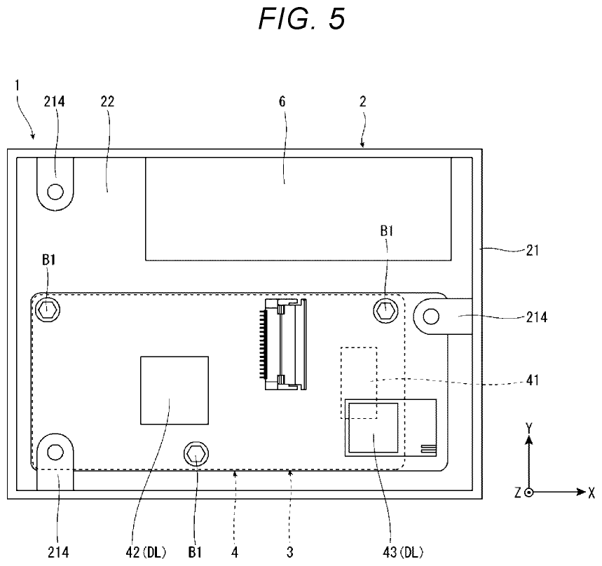

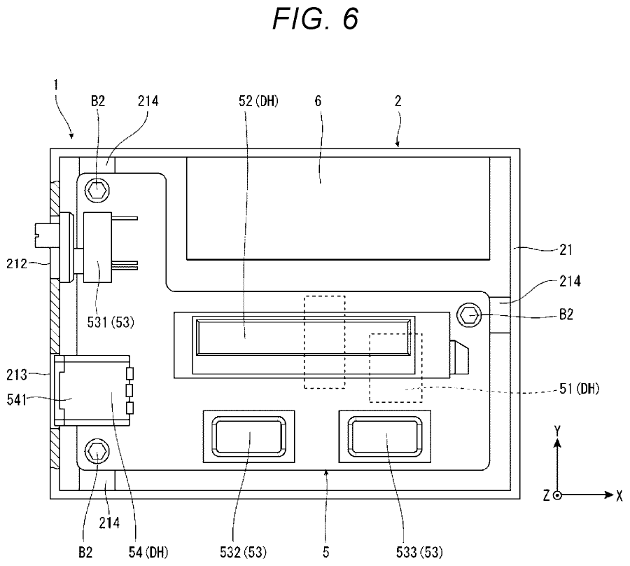

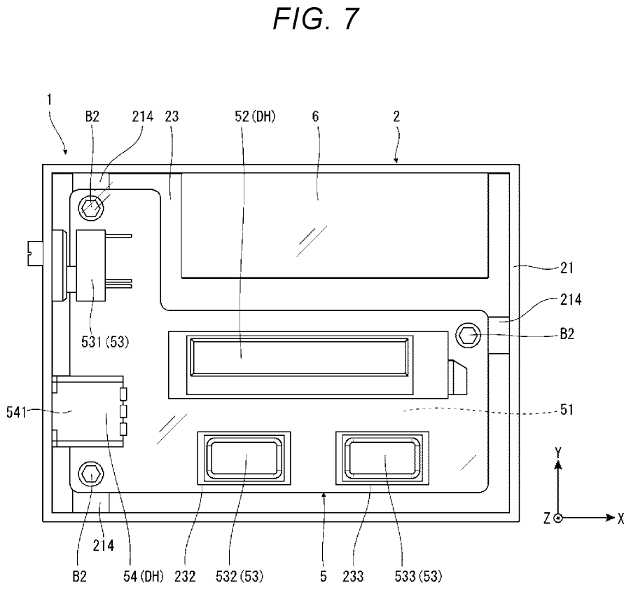

FIG. 1 is an exploded perspective view showing an inertial measurement device according to a preferred embodiment. FIG. 2 is a cross-sectional view showing an inside of the inertial measurement device. FIG. 3 is a plan view showing an inside of an inertial sensor unit. FIG. 4 is a plan view showing an upper surface of the inertial sensor unit. FIG. 5 is a plan view showing an upper surface of a first circuit board. FIG. 6 is a plan view showing an upper surface of a second circuit board. FIG. 7 is a plan view showing an upper surface of the inertial measurement device.

For convenience of description, an X axis, a Y axis, and a Z axis orthogonal to one another are shown in the drawings. Hereinafter, a direction along the X axis is also referred to as an “X-axis direction”, a direction along the Y axis is also referred to as a “Y-axis direction”, and a direction along the Z axis is also referred to as a “Z-axis direction”. An arrow side of each axis is also referred to as a “plus side” and an opposite side from the arrow side is also referred to as a “minus side”. The plus side in the Z-axis direction is also referred to as “upper”. The minus side in the Z-axis direction is also referred to as “lower”.

An inertial measurement device 1 shown in FIG. 1 is an inertial measurement unit (IMU), and measures an acceleration, an angular velocity, a vibration, and an inclination of a measurement target and executes VC determination based on the acceleration and the angular velocity. VC is an environmental vibration standard standardized by the institute of environmental sciences and technology (IEST). The VC determination analyzes which standard such as VC-A, VC-B, VC-C, VC-D, and VC-E is satisfied as the vibration of the measurement target. However, items measured by the inertial measurement device 1 are not particularly limited.

As shown in FIGS. 1 and 2, the inertial measurement device 1 includes a housing 2, and an inertial sensor unit 3, a first circuit board 4, a second circuit board 5, and a battery 6 which are accommodated in the housing 2. Such an inertial measurement device 1 is operated by a power supply of an external device such as a computer or operated by the built-in battery 6.

The housing 2 includes a frame-shaped base 21 that forms a side surface of the housing 2, a bottom plate 22 that is fixed to a lower end portion of the base 21 and forms a bottom surface of the housing 2, and a lid plate 23 that is fixed to an upper end portion of the base 21 and that forms a top surface of the housing 2. The bottom plate 22 is screwed to the base 21. The lid plate 23 is fixed to the base 21 by an adhesive, a double-sided tape, or the like. In the inertial measurement device 1, the bottom plate 22 serves as a mounting surface for a measurement target.

The lid plate 23 has optical transparency to such an extent that information displayed inside the housing 2, in particular, on a display unit 52 to be described later, can be visually recognized through the lid plate 23. The lid plate 23 may be colorless and transparent. A color, a transmittance, or the like of the lid plate 23 may be changed within a range in which the display unit 52 can be visually recognized from outside. That is, the lid plate 23 functions as a window portion through which the display unit 52 can be visually recognized from the outside of the housing 2. Accordingly, the display unit 52 can be visually recognized while the lid plate 23 seals the housing 2 and protects units accommodated therein.

Each of the base 21 and the bottom plate 22 is made of a metal material such as aluminum. The lid plate 23 is made of a glass material. However, constituent materials of the base 21, the bottom plate 22, and the lid plate 23 are not particularly limited.

The battery 6 is disposed on the side surface of the housing 2. The inertial sensor unit 3 and the first circuit board 4 are fastened to the bottom plate 22 (bottom portion of the housing 2) by first screws B1 in a state in which the first circuit board 4 overlaps the inertial sensor unit 3. The second circuit board 5 is fixed to the base 21 (side wall of the housing) by second screws B2. Specifically, the second circuit board 5 is fixed to a plurality of protrusions 214 protruding inward from the side wall of the housing 2 by a plurality of the second screws B2. That is, in the inertial measurement device 1, a portion where the first circuit board 4 is fixed to the housing 2 is different from a portion where the second circuit board 5 is fixed to the housing 2. The first circuit board 4 and the second circuit board 5 overlap each other in a state of being separated from each other in the Z-axis direction, and are electrically coupled to each other by a cable 7. The first circuit board 4 and the second circuit board 5 are disposed parallel to each other.

In the inertial measurement device 1, a heat-generating component DH that easily generates heat and a switch that is operated by an operator are mounted on the second circuit board 5 on a side far from the inertial sensor unit 3. A low-heat-generating component DL that hardly generates heat as compared to the heat-generating component DH is mounted on the first circuit board 4 on a side close to the inertial sensor unit 3. Accordingly, heat generated by the heat-generating component DH and a body temperature of the operator transferred from the switch (hereinafter, also collectively referred to as “heat”) are less likely to be transferred to the inertial sensor unit 3. Therefore, a temperature change in the inertial sensor unit 3 can be effectively prevented, and detection accuracy of the inertial sensor unit 3 is stabilized. As a result, the inertial measurement device 1 can exhibit excellent detection characteristics.

In particular, as described above, the first circuit board 4 and the second circuit board 5 are separated from each other. Therefore, the heat is transferred to the inertial sensor unit 3 mainly through a first heat transfer path passing through the second circuit board 5 and the housing 2 and a second heat transfer path passing through the second circuit board 5, the cable 7, and the first circuit board 4. By separating the first circuit board 4 and the second circuit board 5 from each other, it is possible to secure both the first and second heat transfer paths sufficiently long. Therefore, it is possible to more effectively prevent the temperature change in the inertial sensor unit 3.

Regarding the first heat transfer path, more specifically, in the embodiment, a fixed portion of the first circuit board 4 is different from a fixed portion of the second circuit board 5. Therefore, the first heat transfer path can be made longer. In particular, in the embodiment, the second circuit board 5 is fixed to the base 21, and the inertial sensor unit 3 is fixed to the bottom plate 22. Therefore, the fixed portions can be further separated from each other, and the above-described effect is more remarkable. For example, by disposing a heat insulating material between the base 21 and the bottom plate 22, the first heat transfer path is cut off in the middle, and the above-described effect is more remarkable.

Regarding the second heat transfer path, more specifically, in the embodiment, an entire length of the cable 7 is sufficiently larger than a separation distance between the first circuit board 4 and the second circuit board 5, and the cable 7 is bent in a space between the first circuit board 4 and the second circuit board 5. Accordingly, the second heat transfer path can be made longer. In particular, in the embodiment, a flexible flat cable is used as the cable 7. Therefore, since a surface area of the cable 7 is increased and heat is easily radiated, the above-described effect is more remarkable.

Here, the heat-generating component DH means an electronic component having a relatively large amount of heat generation among various components (circuit elements) mounted on the first and second circuit boards 4 and 5. The low-heat-generating component DL means an electronic component having a relatively small amount of heat generation among the electronic components mounted on the first and second circuit boards 4 and 5. The amount of heat generation to be classified into the heat-generating component DH and the low-heat-generating component DL can be appropriately set according to types of components mounted on the first and second circuit boards 4 and 5, temperature characteristics of the inertial sensor unit 3, detection accuracy required by the user, and the like.

### Inertia Sensor Unit 3

The inertial sensor unit 3 includes an inertial sensor 30 that outputs a signal corresponding to inertia. The inertial sensor unit 3 according to the embodiment is a six-axis inertial sensor, and can independently detect an acceleration in the X-axis direction, an acceleration in the Y-axis direction, an acceleration in the Z-axis direction, an angular velocity around the X axis, an angular velocity around the Y axis, and an angular velocity around the Z axis.

As shown in FIG. 3, the inertial sensor unit 3 includes a case 31 and a mounting board 32 accommodated in the case 31. A connector 33, an angular velocity sensor 34z that detects the angular velocity around the Z axis, an acceleration sensor 35 that detects accelerations in axial directions of the X axis, the Y axis, and the Z axis, and the like are mounted on an upper surface of the mounting board 32. An angular velocity sensor 34x that detects the angular velocity around the X axis and an angular velocity sensor 34y that detects the angular velocity around the Y axis are mounted on a side surface of the mounting board 32. A control IC 36 is mounted on a lower surface of the mounting board 32. In the inertial sensor unit 3, the angular velocity sensors 34x, 34y, and 34z and the acceleration sensor 35 are each the inertial sensor 30. As shown in FIG. 4, the connector 33 is exposed to the outside of the case 31 through an opening formed in an upper surface of the case 31.

Configurations of the angular velocity sensors 34x, 34y, and 34z and the acceleration sensor 35 are not particularly limited as long as the sensors can exhibit the functions. In the embodiment, the angular velocity sensors 34x, 34y, and 34z each include a quartz crystal vibrator that performs flexural vibration, and detect the angular velocity using a Coriolis force. On the other hand, the acceleration sensor 35 includes a silicon MEMS including a comb-shaped fixed electrode and a movable electrode, and detects the acceleration using a change in capacitance formed between the fixed electrode and the movable electrode. The acceleration sensor 35 may include a quartz crystal vibrator, and may detect the acceleration using a change in a vibration frequency of the quartz crystal vibrator.

The quartz crystal vibrator and the silicon MEMS are likely to be affected by the temperature, and detection characteristics thereof vary depending on the temperature change. Therefore, by making it difficult for the heat to be transferred to the inertial sensor unit 3 as described above, stable detection characteristics can be exhibited.

The control IC 36 is, for example, a micro controller unit (MCU), and controls each unit of the inertial sensor unit 3. A storage unit of the control IC 36 stores a program for defining an order and contents for detecting an acceleration and an angular velocity, a program for digitizing detection data and incorporating the digitized detection data into packet data, accompanying data, or the like. One or more electronic components may be mounted on the mounting board 32 as necessary.

The inertial sensor unit 3 is described above, whereas the configuration of the inertial sensor unit 3 is not particularly limited as long as the inertial sensor unit 3 includes at least one inertial sensor 30. For example, the inertial sensor unit 3 may omit the angular velocity sensors 34x, 34y, and 34z. That is, a configuration may be used in which a triaxial acceleration can be detected. On the contrary, the inertial sensor unit 3 may omit the acceleration sensor 35. That is, a configuration may be used in which a triaxial angular velocity can be detected.

### First Circuit Board 4

The first circuit board 4 is a rigid wiring board. As shown in FIG. 5, the first circuit board 4 has a size substantially the same as the inertial sensor unit 3 in a plan view in the Z-axis direction. The first circuit board 4 is mounted on an upper surface of the inertial sensor unit 3, and is fastened together with the inertial sensor unit 3 to the bottom plate 22 by the first screws B1. A connector 41 coupled to the connector 33 is disposed at a lower surface of the first circuit board 4. A processing unit 42 and a wireless communication unit 43 serving as the low-heat-generating components DL are disposed at an upper surface of the first circuit board 4.

The processing unit 42 is, for example, a processing circuit including an MCU or the like. A storage unit provided in the processing unit 42 stores a program, data, or the like necessary for processing performed by the inertial measurement device 1. The processing unit 42 is electrically coupled to the inertial sensor unit 3 via the connector 33, and processes a detection signal of the inertial sensor unit 3 to execute analysis processing for an acceleration, an angular velocity, a vibration, an inclination, VC determination, or the like of a measurement object. According to such a configuration, it is possible to output, instead of the detection signal itself of the inertial sensor unit 3, information obtained by processing the detection signal to the outside. Therefore, the processing of the detection signal does not need to be performed on an external device side coupled to the inertial measurement device 1, and a processing load of the external device can be reduced and cost can be reduced. The inertial measurement device 1 can be easily used by a user having poor knowledge required for processing the detection signal. Therefore, convenience of the inertial measurement device 1 is improved.

The processing unit 42 includes a plurality of measurement modes. In the embodiment, the processing unit 42 includes an acceleration measurement mode for measuring the acceleration of the measurement target, an angular velocity measurement mode for measuring the angular velocity of the measurement target, a vibration measurement mode for measuring the vibration of the measurement target, an inclination measurement mode for measuring the inclination of the measurement target, and a VC measurement mode for executing the VC determination. Then, the processing unit 42 operates in one mode selected by the user. An operation method for the processing unit 42 is not particularly limited. For example, all items may be analyzed regardless of the selected mode, and only an analysis result of the item corresponding to the selected mode may be output.

The processing unit 42 is implemented by the MCU, so that the processing unit 42 can be driven with a small amount of heat generation and low power consumption. As described above, since the processing in the processing unit 42 is limited to processing with a relatively low load such as processing of the detection signal of the inertial sensor unit 3, a load is less likely to be applied to the processing unit 42, and the heat generation can be prevented accordingly. As described above, in addition to the fact that the amount of heat generation is originally small, the processing load is reduced to prevent the heat generation. Therefore, the processing unit 42 can be mounted on the first circuit board 4 as the low-heat-generating component DL. By mounting the processing unit 42 on the first circuit board 4, a signal transmission path to the inertial sensor unit 3 is shortened. Therefore, it is possible to effectively prevent mixing of noise into the detection signal of the inertial sensor unit 3.

The wireless communication unit 43 communicates with a host computer when the inertial measurement device 1 is used in a communication mode. The wireless communication unit 43 is, for example, a wireless communication IC, and performs wireless communication using Bluetooth (registered trademark), in particular, Bluetooth low energy (BLE). Accordingly, it is possible to perform communication with low power consumption. However, a communication standard is not particularly limited. Other wireless communication such as ZigBee (registered trademark), Wi-SUN (registered trademark), or Wi-Fi (registered trademark) may be used. Such a wireless communication unit 43 has a small amount of heat generation, and belongs to the low-heat-generating component DL in the inertial measurement device 1.

One or a plurality of low-heat-generating components DL may be mounted on the first circuit board 4 as necessary.

### Second Circuit Board 5

The second circuit board 5 is a rigid wiring board. As shown in FIG. 6, the second circuit board 5 is disposed above the first circuit board 4 and overlaps the first circuit board 4 in a state of being separated from the first circuit board 4. Further, the second circuit board 5 is coupled to the first circuit board 4 via the cable 7 (see FIG. 2). In this way, the first circuit board 4 and the second circuit board 5 overlap each other, so that it is possible to reduce spread of the inertial measurement device 1 in the X-axis direction and the Y-axis direction, that is, a footprint corresponding to an installation surface of the inertial measurement device 1. Therefore, the inertial measurement device 1 can be mounted on a narrower surface, and the convenience of the inertial measurement device 1 is improved. A power supply interface 51, the display unit 52, a wired communication unit 54, and a switch 53 that serve as the heat-generating components DH are mounted on an upper surface of the second circuit board 5.

The power supply interface 51 is a power supply circuit that selects a power supply destination and charges the battery 6. When the power supply of the external device can be used, the power supply interface 51 drives each unit by the power supply of the external device, and charges the battery 6 when the battery 6 can be charged. On the other hand, when the power supply of the external device cannot be used, power is supplied from the battery 6 to drive each unit.

The display unit 52 is mounted on the upper surface of the second circuit board 5, and is visible through the transparent lid plate 23. The display unit 52 is, for example, an organic EL panel or a liquid crystal panel, and displays various types of information. By providing the display unit 52 in this manner, the convenience of the inertial measurement device 1 is improved. When the display of the various types of information is performed by light emission of the display unit 52, it is possible to allow the user to visually recognize only the information displayed on the display unit 52 excluding an internal structure by adopting the lid plate 23 colored in a color of a predetermined system.

The switch 53 includes a power switch 531, a mode switching switch 532, and a determination switch 533. The power switch 531 is a switch for selecting ON/OFF of the power supply. The mode switching switch 532 is a switch that switches a measurement mode. In the embodiment, every time the mode switching switch 532 is pressed, the acceleration measurement mode, the angular velocity measurement mode, the vibration measurement mode, the inclination measurement mode, and the VC measurement mode are switched in this order. The determination switch 533 is a switch for determining “OK” for the content selected by the mode switching switch 532.

The power switch 531 is a slide switch including a protruding tab, and protrudes to the outside through an opening 212 formed in the side surface of the housing 2. On the other hand, the mode switching switch 532 and the determination switch 533 are each a press-type switch, and as shown in FIG. 7, protrude to the outside through openings 232 and 233 formed in the lid plate 23.

The wired communication unit 54 includes, for example, a USB female connector 541, and performs wired communication with the external device. The female connector 541 is exposed to the outside through an opening 213 formed in the side surface of the housing 2. The female connector 541 is disposed side by side with the power switch 531. A configuration of the wired communication unit 54 is not particularly limited as long as the wired communication unit 54 can perform the wired communication with the external device.

One or a plurality of heat-generating components DH may be mounted on the second circuit board 5 as necessary.

The configuration of the inertial measurement device 1 is described above. Next, a method for using the inertial measurement device 1 will be described. As described above, the inertial measurement device 1 includes three interfaces, that is, the wireless communication unit 43, the wired communication unit 54, and the switch 53. The electronic device 1 includes a wireless communication mode used in a state of being coupled to the external device via the wireless communication unit 43, a wired communication mode used in a state of being coupled to the external device via the wired communication unit 54, and a single mode used in the inertial measurement device 1 alone without being coupled to the external device. As described above, a plurality of operation modes are provided, so that the user can select an operation mode suitable for a use situation, and the convenience of the inertial measurement device 1 is improved.

In the case of the single mode, the user may select and execute a desired mode by operating the mode switching switch 532 and the determination switch 533 while checking the information displayed on the display unit 52. In the case of the wireless communication mode or the wired communication mode, the user may couple the external device and the inertial measurement device 1 via the wireless communication unit 43 or the wired communication unit 54, and select and execute a desired mode by operating the inertial measurement device 1 using a dedicated application installed in the external device.

The inertial measurement device 1 is described above. The inertial measurement device 1 includes the inertial sensor 30, the first circuit board 4 disposed on one side of the inertial sensor 30, that is, on the upper side of the inertial sensor 30, the second circuit board 5 disposed on the opposite side of the first circuit board 4 from the inertial sensor 30, that is, on the upper side of the first circuit board 4, on which the heat-generating component DH is mounted, and the housing 2 that accommodates the inertial sensor 30, the first circuit board 4, and the second circuit board 5. In this way, by mounting the heat-generating component DH that easily generates the heat on the second circuit board 5 on the side far from the inertial sensor 30, the heat generated by the heat-generating component DH is less likely to be transferred to the inertial sensor 30. Therefore, the temperature change in the inertial sensor 30 can be effectively prevented, and detection accuracy of the inertial sensor 30 is stabilized. As a result, the inertial measurement device 1 can exhibit excellent detection characteristics.

As described above, the first circuit board 4 and the second circuit board 5 are separated from each other. Accordingly, it is possible to secure a sufficiently long heat transfer path between the heat-generating component DH and the inertial sensor 30. Therefore, the heat is less likely to be transferred to the inertial sensor 30, and the temperature change in the inertial sensor 30 can be more effectively prevented.

As described above, the inertial measurement device 1 includes the cable 7 that electrically couples the first circuit board 4 and the second circuit board 5. Accordingly, for example, the entire length of the cable 7 is sufficiently longer than the separation distance between the first circuit board 4 and the second circuit board 5, and the cable 7 is bent in the space between the first circuit board 4 and the second circuit board 5, so that the second heat transfer path can be further lengthened. Therefore, the heat is less likely to be transferred to the inertial sensor 30, and the temperature change in the inertial sensor 30 can be more effectively prevented.

As described above, the portion where the first circuit board 4 is fixed to the housing 2 is different from the portion where the second circuit board 5 is fixed to the housing 2. Accordingly, the first heat transfer path can be made longer. Therefore, the heat is less likely to be transferred to the inertial sensor 30, and the temperature change in the inertial sensor 30 can be more effectively prevented.

As described above, the inertial measurement device 1 includes the battery 6. The heat-generating component DH is the power supply interface 51 that selects whether to receive the power supply from an external power supply or to receive the power supply from the battery 6. Accordingly, the inertial measurement device 1 can be driven without an external power supply, thereby improving the convenience of the inertial measurement device 1.

As described above, the heat-generating component DH is the display unit 52. Accordingly, even if the inertial measurement device 1 is not coupled to the external device, a measurement result can be notified to the user only by the inertial measurement device 1. Therefore, the inertial measurement device 1 is highly convenient.

As described above, the housing 2 includes the lid plate 23 as a window portion through which the display unit 52 can be visually recognized. Accordingly, the display unit 52 accommodated in the housing 2 can be visually recognized from the outside of the housing 2.

As described above, the inertial measurement device 1 includes the switch 53 mounted on the second circuit board 5 and operated by the user. In this way, by mounting the component operated by the user on the second circuit board 5, a body temperature of the user is less likely to be transferred to the inertial sensor 30. Therefore, the temperature change in the inertial sensor 30 can be effectively prevented, and detection accuracy of the inertial sensor 30 is stabilized. As a result, the inertial measurement device 1 can exhibit excellent detection characteristics.

As described above, the inertial measurement device 1 includes the processing unit 42 that is mounted on the first circuit board 4 and that processes the detection signal of the inertial sensor 30. In this way, by mounting the processing unit 42 on the first circuit board 4, a signal transmission distance between the inertial sensor 30 and the processing unit 42 can be shortened, and the noise is less likely to be mixed into the detection signal of the inertial sensor 30.

As mentioned above, although the inertial measurement device according to the disclosure is described based on illustrated embodiments, the disclosure is not limited thereto. A configuration of each part can be replaced with any configuration having a similar function. Any other constituents may be added to the present disclosure.

What is claimed is:

1. An inertial measurement device comprising:
an inertial sensor;
a first circuit board disposed on one side of the inertial sensor;
a second circuit board that is disposed on an opposite side of the first circuit board from the inertial sensor and on which a heat-generating component is mounted; and
a housing configured to accommodate the inertial sensor, the first circuit board, and the second circuit board.

2. The inertial measurement device according to claim 1, wherein
the first circuit board and the second circuit board are separated from each other.

3. The inertial measurement device according to claim 2, further comprising:
a cable configured to electrically couple the first circuit board and the second circuit board.

4. The inertial measurement device according to claim 1, wherein
a portion where the first circuit board is fixed to the housing is different from a portion where the second circuit board is fixed to the housing.

5. The inertial measurement device according to claim 1, further comprising:
a battery, wherein
the heat-generating component is a power supply interface configured to select whether to receive power supply from an external power supply or to receive power supply from the battery.

6. The inertial measurement device according to claim 1, wherein
the heat-generating component is a display unit.

7. The inertial measurement device according to claim 6, wherein
the housing includes a window portion through which the display unit is to be visually recognized.

8. The inertial measurement device according to claim 1, further comprising:
a switch that is mounted on the second circuit board and that is operated by a user.

9. The inertial measurement device according to claim 1, further comprising:
a processing unit mounted on the first circuit board and configured to process a detection signal of the inertial sensor.
